(19) United States
(12) Patent Application Publication
(10) Pub. No.: US 2011/0063212 A1
(43) Pub. Date: Mar. 17, 2011

(54) Apparatus for Input of Control Signals for Moving an Object

(76) Inventors: Michael Ries, Olching (DE); Manfred Engelhardt, Grafrath (DE)

(21) Appl. No.: 12/988,126

(22) PCT Filed: Apr. 16, 2009
(86) PCT No.: PCT/EP2009/002802

§ 371 Date: Nov. 30, 2010

(30) Foreign Application Priority Data
Apr. 16, 2008 (DE) 10 2008 019 144.2

(51) Int. Cl. G06F 3/033

(52) U.S. Cl. 345/157

(57) ABSTRACT

In one embodiment an apparatus for input of control signals is for moving an object in three spatial directions and three rotational directions and for connection to a computational unit with a display which displays at least partial areas of the object. The apparatus comprises a carrier element, an input element which is moveable with respect to the carrier element for input of the control signals, and an actuator, which is arranged at the carrier element. The actuator is designed as a rotatable or slideable element in order to detect further inputs of a user and extends at least partially around the input element.

### 1. TECHNICAL FIELD

The invention relates to an apparatus for input of control signals for moving an object in three spatial directions and in three rotational directions.

### 2. THE PRIOR ART

In various fields such as computer-aided design (CAD) a three-directional object is moved on a display. This requires translations of the object in three spatial directions and rotations around these axes. To this end, specific input devices have been developed which provide control signals to a computational unit for representing the object. The present application is directed to an improvement of such input devices.

The German patent application DE 36 11 337 A1 describes an optoelectronic assembly which is arranged in a plastic sphere and which can simultaneously detect six components, namely translations along three axes and angular rotations around three axes. To this end, six light emitting devices are arranged in equal angular distances with respect to each other in a plane. Each light emitting device is located behind a fixedly arranged slit diaphragm. The relative movements or relative positions are detected by light-sensitive detectors which are movably arranged with respect to the assembly of light emitting devices and slit diaphragms. The detecting axis of a detector is essentially orthogonal to the slit direction.

Further documents which show the technical background of the invention are DE 10 15 87 75 A1, DE 10 15 87 76 A1, and the DE 10 15 87 77 A1.

However, applicant has found that such input devices are insufficient for moving three-directional objects on a display. For example, further inputs may be necessary which interrupt or disturb the flow of work. Such inputs are made, for example, via a keyboard or a mouse. This is particularly disturbing when the inputs have to be made frequently or require a sequence of inputs.

It is therefore the problem of the present invention to provide an apparatus for the input of control signals for moving an object in three spatial directions and three rotational directions which overcomes the disadvantages of the prior art and which provides in particular ergonomic and extended possibilities for input of a user.

### 3. SUMMARY OF THE INVENTION

According to a first aspect of the invention, this problem is solved by an apparatus according to claim 1. In one example, an apparatus is for input of control signals for moving an object in three spatial directions and three rotational directions and for connection to a computational unit with a display which represents at least partial areas of the object. The apparatus comprises a carrier element, an input element which is movable with respect to the carrier element and which is for input of the control signals, and an actuator which is arranged at the carrier element or at the input element. The actuator is designed so as to influence the representation of the size of the object on the display and/or to change the sensitivity of the input of at least one control signal.

The additional actuator enables to directly influence important parameters during moving of an object on the display, namely the size of the object and/or the sensitivity of the input of the control signals. Due to the arrangement of the actuator at the carrier element or at the input element, the actuator can be actuated with the same hand as the input element. Changing to another hand and/or to another input medium such as a mouse which disturbs or delays the flow of work is therefore not necessary.

According to a second aspect of the invention, the problem of the invention is solved by an apparatus according to claim 2. In one embodiment, an apparatus is for input of control signals for moving an object in three spatial directions and three rotational directions and for connection to a computational unit with a display which represents at least partial areas of the object. The apparatus comprises a carrier element, an input element which is movable with respect to the carrier element and which is for input of the control signals, and an actuator which is arranged at the carrier element. The actuator is designed as a rotational or translational element in order to receive further inputs of a user and extends at least partially around the input element.

Since the actuator extends at least partially around the input element, the actuator can be manipulated by the same hand which actuates the input element. For example, the input element can be actuated by a part of the heel of the hand and the actuator can be actuated by the fingertips. The actuator and the input element therefore can be actuated simultaneously which leads to a substantially faster flow of work. This is particularly advantageous for input parameters which have to be changed frequently in connection with the input of control signals by the input element.

According to a third aspect, the problem of the invention is solved by an apparatus according to claim 3. In one embodiment, an apparatus is for input of control signals and for moving an object in three spatial directions and three rotational directions and for connection to a computational unit with a display which represents at least partial areas of the object. This apparatus comprises a carrier element, an input element which is movable with respect to the carrier element and which is for input of the control signals, and an actuator which is designed as a rotational or translational element. The actuator is arranged at the input element.

In contrast to the previous embodiments wherein the actuator is arranged at the carrier element, in this case the actuator is arranged at the input element. Also this arrangement enables to actuate the actuator and the input element simultaneously.

It is a common feature of all three solutions that they enable more economic and extended possibilities for inputs of a user compared to the solutions known from the prior art by an actuator which is arranged at the input element or at the carrier element.

In a preferred embodiment, the actuator is designed as a rotational element which is rotatably arranged around the input element. The embodiment as a rotational element is particularly advantageous in order to quickly pass through a large range of values, as well as to select a value from a continuous range of values.

It is further preferred that the actuator encompasses the input element in a circle. Due to the circular shape, the hand of the user can grip the actuator at any position and does not have to search for a preferred grip position.

It is further preferred that the grip surface of the actuator is curved in a direction orthogonal to the rotational direction. The actuator therefore adjusts to the position and the direction of the fingertips and provides a convenient resting surface. The actuator can therefore be gripped and moved particularly well.

In a further embodiment, the actuator input is a selection from a display of a carrier. This enables further input possibilities by the apparatus as an alternative to conventional inputs via a mouse and a display of the computational unit. For example, in this way a parameter can be selected whose value is then input by the actuator.

It is further preferred that the actuator input modifies the sensitivity of the input of control signals. The sensitivity is closely connected with the input of the control signals themselves and therefore can be advantageously modified by the apparatus with the same hand so that no interruption of the flow of work by changing to another input medium is necessary.

In a further embodiment, the carrier element comprises keys for additional inputs of a user, wherein a lighting of the keys depends on a selectable function of the apparatus. Also this alternative extends the input possibilities by the apparatus, for example for particularly frequently required functions, without repeatedly having to repeat a selection in menus.

In a preferred embodiment, the input element is arranged on a printed circuit board of the carrier element. This enables a particularly easy mounting of the input element and therefore provides a simple possibility for detecting the movements of the actuator. It is further preferred that the movement of the actuator is detected by a light barrier or a photo sensor. The movement therefore can be detected without contact so that the measuring device is not subject to wear.

In a further embodiment a covering plate of the carrier element comprises a preferably circular recess which extends through a part of the input element. This enables an advantageous mounting of the input element on the printed circuit board of the apparatus, as explained above. Preferably, the actuator is arranged at the boundary of this recess so that it is located in the direct proximity of the input element and can be actuated with the fingertips of the hand which actuates the input element.

Preferably, the input element comprises exchangeable caps so that the user can select a particularly suitable shape.

In a further embodiment the control signals are for moving of an object in less than three spatial directions and/or less than three rotational directions. In this way, the input element can be adapted to a desired functionality for moving of two- and three-dimensional objects on a display, for example exclusively for the input of rotations of an object or for moving an object in a plane and rotations of the object around an axis orthogonal to this plane.

Further preferred embodiments are described in further dependent patent claims.

### 4. SHORT DESCRIPTION OF THE DRAWINGS

In the following detailed description, currently preferred embodiments of the invention are described with respect to the following figures:

FIG. 1: illustrates a perspective view of a preferred embodiment of an apparatus for input of control signals for moving an object according to the invention;

FIG. 2: illustrates a further perspective view of the apparatus of FIG. 1, wherein the input element was removed;

FIG. 3: is a detail view of FIG. 2;

FIG. 4: illustrates a perspective view of the lower side of the apparatus of FIGS. 1 and 2;

FIG. 5: illustrates a further perspective view of the lower side of FIG. 4;

FIG. 6: illustrates a perspective view of a further embodiment of the apparatus according to the invention;

FIG. 7: illustrates a perspective view of an input element;

FIG. 8: illustrates a top view of an embodiment of the apparatus according to the invention;

FIG. 9: shows a cross-section of the apparatus of FIG. 1; and

FIG. 10: shows a cross-section of the apparatus of FIG. 6.

### 5. DETAILED DESCRIPTION OF THE PREFERRED EMBODIMENTS

In the following, currently preferred embodiments of the present invention are described with respect to an apparatus for input of control signals for moving an object on a display. However, it should be understood that the invention may be used in other fields, for example for input of control signals for remote control of an object or for the input of forces and positions for control purposes.

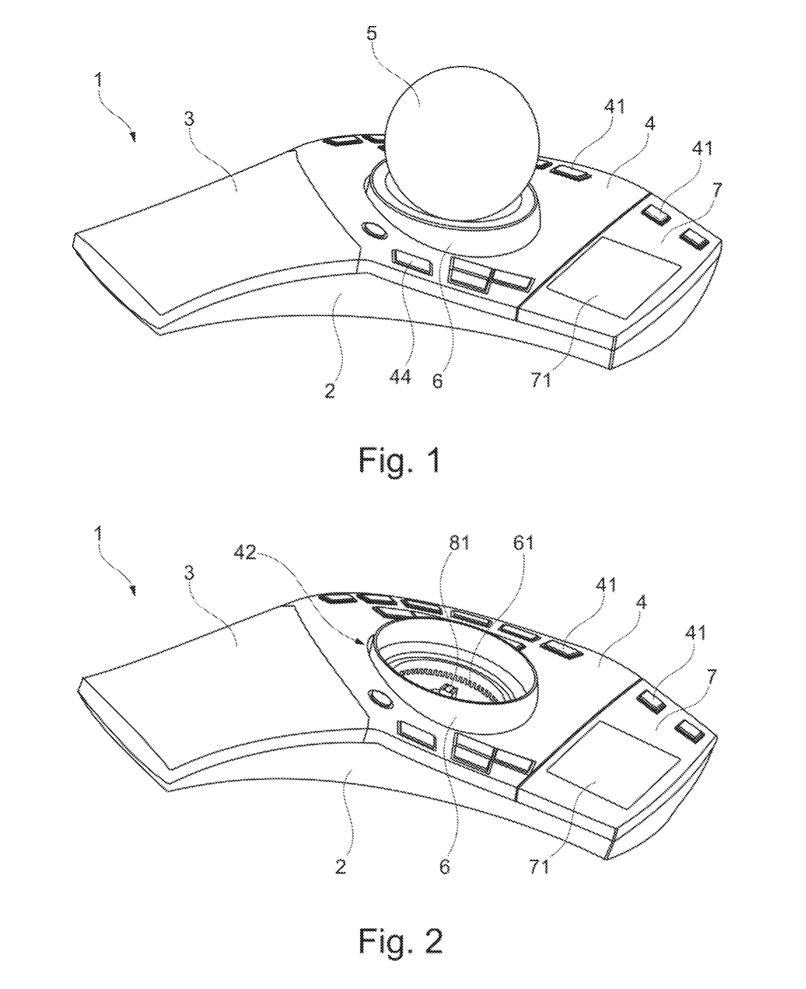

FIG. 1 shows a perspective view of a preferred embodiment of an apparatus 1 for input of control signals for moving an object in three spatial directions and three rotational directions according to the invention. This apparatus will also be designated as a 3D sensor in the following. The 3D sensor can be connected to a computational unit with a display. The display displays at least partial areas of the object.

As can be recognized in FIG. 1, the 3D sensor 1 comprises a carrier element 2, a hand rest 3, a covering plate 4, an input element 5, an actuator 6, and a display area 7. In the illustrated design, 3D sensor 1 is intended for the conventional use with the left hand. Therefore, the hand rest 3 is arranged left of the input element 5. Input element 5 is movable arranged with respect to carrier element 1 and is for input of control signals in three spatial directions and three rotational directions by corresponding movements of the input element. The sensor in the interior of the input element 5 may be, for example, the 3D measuring system described in the patent application DE 10 2006 058 805.

Actuator 6 is arranged in the area of the covering plate 4 and is for detecting of further inputs of a user. A display area 7 with a display 71 is arranged beside the covering plate 4. In further embodiments which are not illustrated, display 71 is arranged in the area of the hand rest 3 or the covering plate 4.

In the embodiment illustrated in FIG. 1, the actuator 6 extends around input element 5. This enables that the hand of the user can grip the input element 5 in many positions and simultaneously can grip actuator 6 with the fingertips. Therefore, a simultaneous input of control signals by input element 5 and of further signals by the actuator 6 is possible. In this embodiment, actuator 6 is pivot-mounted so that inputs of the user can be detected by a rotation of the actuator 6.

It is particularly preferred that the actuator 6 has a circular shape so that the hand does not have to search for a particular grip position in order to grip the actuator 6. Gripping the actuator is further supported by a convex curvature of the surface of actuator 6 orthogonal to a movement direction of actuator 6 which can also be recognized in FIG. 1. In an embodiment which is not illustrated, the surface of the actuator is concavely curved which generates a circumferential, recessed grip. In further embodiments which are not illustrated, the surface of actuator 6 comprises single recesses as recessed grips for the fingertips, or the surface is not curved at all. In a further variant, actuator 6 extends only along a part of input element 5, preferably in an area which can be reached by the fingers of the hand when the hand grips the input element 5.

In a further embodiment which is also not illustrated, the actuator 6 for detecting inputs of a user is arranged at other locations of the 3D sensor. For example, the actuator 6 can be arranged at the surface of the input element 5. Such an actuator can be designed as a turning knob whose rotational axis extends essentially in a radial direction of input element 5 or along a symmetry axis of input element 5. Alternatively, the rotational axis may extend parallel to the surface of the input element 5 wherein the rotational axis is turned by a finger, similar to a computer mouse with a turning knob. In a further variant, the actuator 6 is designed as a slide on the surface of input element 5.

In further embodiments which are not illustrated, one or more actuators for detecting inputs are arranged on cover plate 4 or in display area 7 and are respectively designed as a turning knob with different radii and different rotational axes (orthogonal, tilted, or parallel to the surface of cover plate 4 or display area 7), or as slides.

In the embodiment of FIG. 1, keys 41 for further inputs of the user are arranged on cover plate 4 and/or in display area 7. Keys 41 may be used, for example, for frequently used functions so that these functions can be selected without having to navigate through menus. The lighting of the keys may depend on a select mode of the 3D sensor and therefore supports inputs of the user. The mode of the 3D sensor can be selected by keys 41 or by the computational unit connected to the 3D sensor.

FIG. 1 further shows a display 71 which is arranged in display area 7 and which displays, for example, inputs of the user by the input element 5, actuator 6, or keys 41. In one embodiment, display 71 displays a menu which can be navigated by actuator 6. A selection is made by pressing a key 44. In one embodiment, actuator 6 and/or input element 5 are designed so that they fulfill the function of an “enter” or “input” key, for example by being designed as a push button. Such a selection leads to the choice of a parameter whose value can be input by the actuator. The described menu selection enables further input possibilities for the 3D sensor, as an alternative to the conventional input via a keyboard or a mouse and a display.

In a preferred embodiment, the input by actuator 6 concerns the sensitivity for the input of movements of the input element 5. This sensitivity is closely connected to the input of the control signals and may be advantageously performed by the 3D sensor itself using the same hand, without requiring an interrupt of the flow of work. The selected sensitivity may concern all control signals or only a part of the control signals. Also in this embodiment, actuator 6 may be arranged, as described above, in locations other than illustrated in FIG. 1. In a variant of this embodiment, actuator 6 changes the size of the object on the screen of the computational unit (“zoom”).

FIG. 2 shows a further perspective view of a preferred embodiment of the apparatus of FIG. 1. In comparison to FIG. 1, input element 5 has been removed. This figure makes it clear that input element 5 in FIG. 1 is arranged in a recess 42 of cover plate 4 and extends partially through recess 42. Actuator 6 is arranged at the boundary of recess 42 and also extends partially through recess 42.

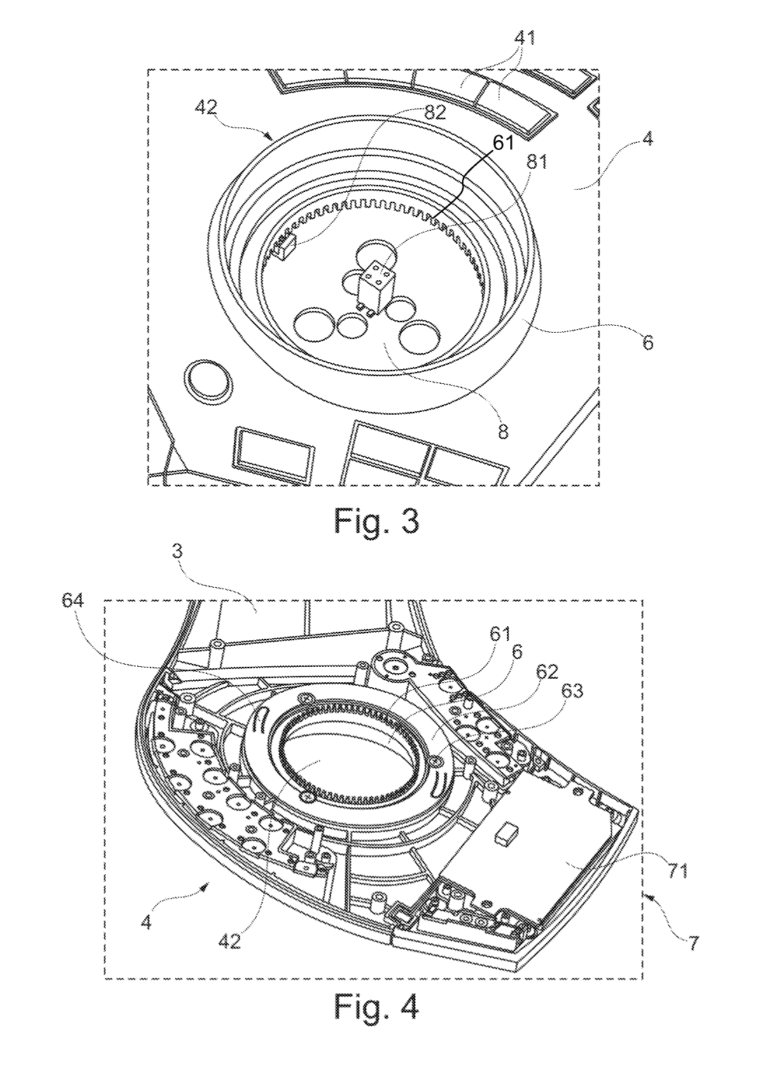

FIG. 2 further opens the view on a socket 81 which is arranged on a printed circuit board (not illustrated) and which is for contacting the input element 5. Further, slits 61 can be recognized at the lower end of actuator 6 which are used for detecting the movement of actuator 6. This will be explained in the following in connection with FIG. 3 to 5.

FIG. 3 shows a detail view of FIG. 2, in particular a part of cover plate 4 with keys 41 and the recess 42. Recess 42 opens the view on part of the printed circuit board 8 with the socket 81 for contacting the input element 5. Further, printed circuit board 8 hosts a light barrier 82 which is arranged so that the slits 61 of actuator 6 cause a signal in light barrier 82. This measuring arrangement can detect rotational movements of actuator 6 without contact which is therefore subject to only minor wear. This measuring arrangement can also be employed in connection with other embodiments of actuator 6, for example for detecting a linear movement of actuator 6. Alternatively, light barrier 82 can be arranged at actuator 6 and the slits 61 can be arranged on printed circuit board 8 or at any other component of the 3D sensor which is movable with respect to actuator 6.

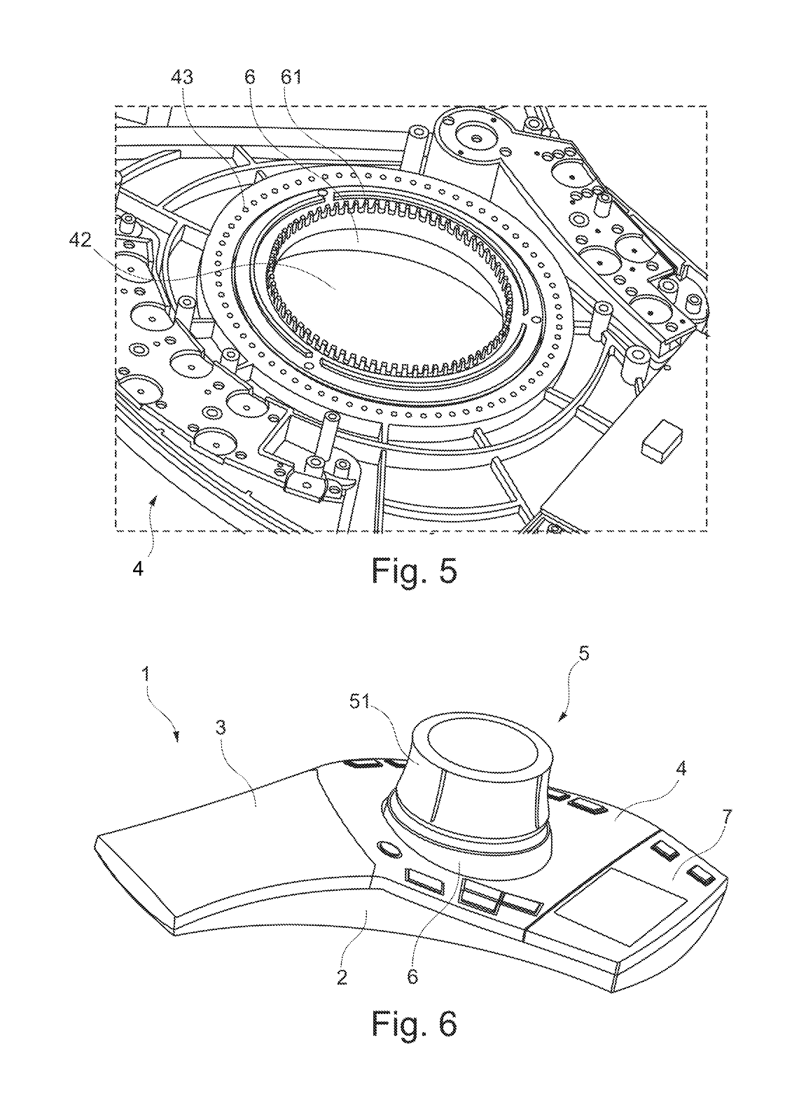

FIG. 4 shows a perspective view of a lower side of the 3D sensor 1 from FIGS. 1 and 2 in which the carrier element 2 and the printed circuit board 8 are removed. Visible are the lower side of the hand rest 3, the lower side of the covering plate 4 with the recess 42, and the lower side of the display area 7 with the display 71. This figure illustrates again that actuator 6 is arranged at the boundary of recess 42 and partially extends through recess 42. Further, FIG. 4 shows a mounting ring 62 which is connected by screws 63 with actuator 6 and which fixes actuator 6 in recess 42. Mounting ring 62 has one or more engagement projections 64 which provide a stepwise movement of actuator 6. This will be explained in connection with the following FIG. 5.

FIG. 5 shows a further perspective view of the lower side of the 3D sensor from FIG. 4 in which in comparison to FIG. 4 the mounting ring 62 has been removed. The figure illustrates recess 42 of covering plate 4 and actuator 6 with slits 61. Removal of mounting ring 62 enables a free view on holes 43 which are preferably arranged on the lower side of covering plate 4 at the boundary of recess 42. Holes 42 are arranged so that they engage the engagement projections 64 of mounting ring 62 in FIG. 4. This causes a stepwise progression during movement of actuator 6, wherein the step size is determined by the distance of holes 43. In a variant, the engagement projections are arranged at covering plate 4 and holes 43 are arranged on mounting ring 62. Alternatively, engagement projections 64 and holes 43 are arranged in other suitable areas of actuator 6 and covering plate 4, in particular at the boundary of recess 42.

In further variants, the step size of the movement of actuator 6 can be modified, or the movement can be switched to a continuous movement. In further embodiments, the step size is associated with a respective function of the actuator, as described above.

FIG. 6 shows a perspective view of a further embodiment of the 3D sensor 1 in which again carrier element 2, hand rest 3, covering plate 4, input element 5, actuator 6, and display area 7 are illustrated. In contrast to FIG. 1, grip area 51 of input element 5 is not shaped as a sphere, but forms a cap with a flat surface. Other shapes suitable for gripping the grip area 51 are conceivable. In a preferred embodiment, the input element 5 can be exchanged so that a user can select a suitable shape. Exchangeability comprises both exchanging of the whole input element 5 as well as exchanging only grip area 51.

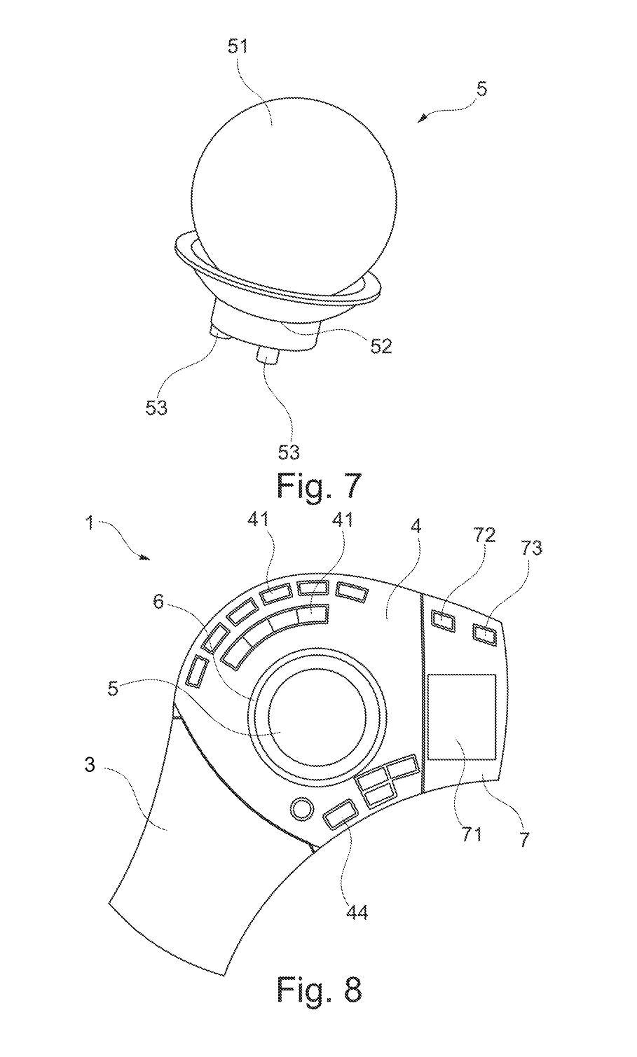

FIG. 7 illustrates a perspective view of input element 5 of 3D sensor 1 of FIG. 1 with a spherical grip area 51 and a mounting area 52. Further, projections 53 are illustrated which can be used for fixing input element 5, for example on carrier element 2 of the 3D sensor 1 shown in FIG. 1. As already mentioned, the whole input element 5 or only grip area 51 may be exchangeable.

FIG. 8 shows a top view of an embodiment of a 3D sensor according to the invention. Again, a hand rest 3, a covering plate 4, an input element 5, an actuator 6, and a display area 7 of 3D sensor 1 are illustrated. In the area of cover plate 4 and/or display area 7, keys 41 are arranged to which fixed or changing functions can be assigned together with different lightings, as explained above in connection with FIG. 1. As shown in the top view of FIG. 8, keys 41 may be arranged in a circle around input element 5 so that keys 41 can be reached with the same hand which grips the input element 5.

In an embodiment, the 3D sensor can be switched over so that the control signals generated by the input element can be used for moving an object in less than three spatial directions and/or less than three rotational directions. In this way, the input element can be switched over to a respectively desired functionality when moving two- and three-directional objects on a display. For example, the 3D sensor could exclusively be used for input of rotations of an object. Another example is moving of an object in a plane and rotating it around an axis orthogonal to this plane. To this end, one or more switch buttons could be provided, for example a button “2D/3D” 44, as illustrated in FIG. 8.

FIG. 8 further shows a display 71 in display area 7 in which a selection menu is shown. As described above, actuator 6 can be used to make a selection in this menu. Key 73 can be used to display a menu on display 71, and a further key 72 could switch back the display to the conventional display mode.

In a further embodiment, the inputs of the 3D sensor are directly delivered to a computer where they are processed by a corresponding device driver. The processed data may then be sent, for example for display on a display 71, to the 3D sensor. This has the advantage that the processing unit of the 3D sensor may be simple and that necessary adjustments of the device driver 3D sensor can be made at any time on the connected computer.

Alternatively, the generated control signals may be directly processed in a processing unit of the 3D sensor. Such a 3D sensor has the advantage that it is independent of a particular computing environment.

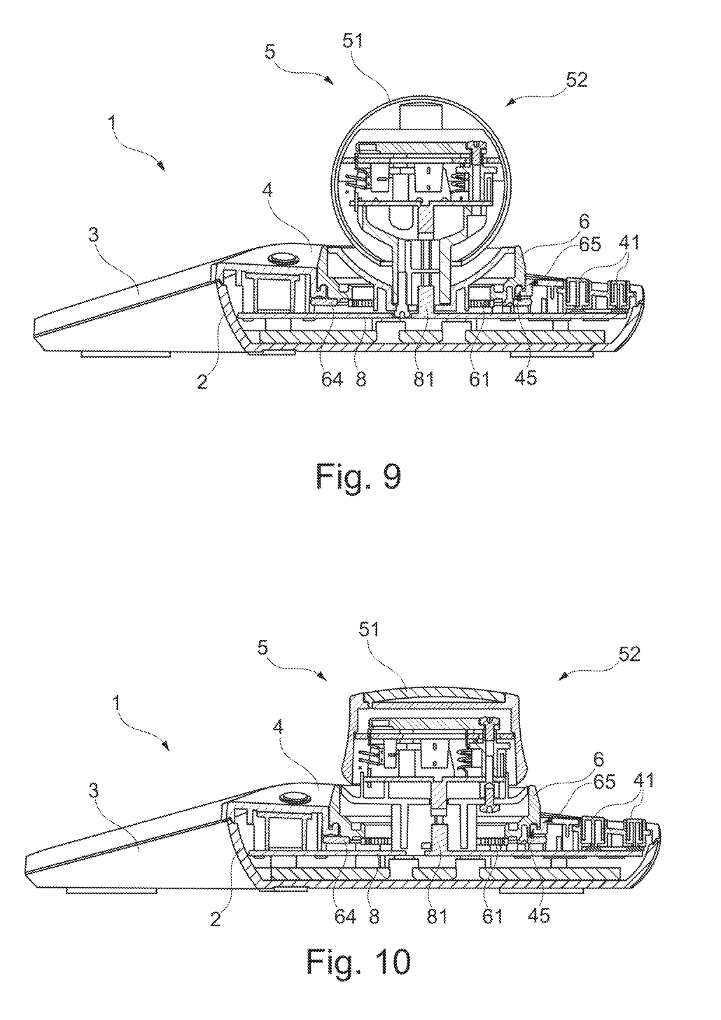

FIG. 9 shows a cross-section of the 3D sensor of FIG. 1 in which carrier element 2, hand rest 3, cover plate 4, input element 5 and actuator 6 are illustrated. Cover plate 4 comprises keys 41 for inputs of a user. Input element 5 has a spherical grip area 51. A sensor 52 is located inside input element 5 for input of control signals in three spatial directions and three rotational directions, as described above in connection with FIG. 1. Input element 5 is in contact with printed circuit board 8 via socket 81. Printed circuit board 8 is arranged between carrier element 2 and cover plate 4.

The cross-section of FIG. 9 also illustrates that actuator 6 extends around input element 5. FIG. 9 further illustrates slits 61 for registering movements of actuator 6, for example using a light barrier (not illustrated) and mounting ring 64 (see FIG. 4) which fixes actuator 6 with respect to cover plate 4. The same purpose has projection 65 of actuator 6 and a corresponding projection 45 of cover plate 4 which engage each other.

FIG. 10 shows a cross-section of the 3D sensor of FIG. 6, similar to the cross-section of FIG. 9. The description of the reference numerals from FIG. 10 therefore corresponds to those of FIG. 9. In contrast to FIG. 9, the grip surface 51 of input element 5 is designed as a cap.

1. Apparatus for input of control signals for moving an object in three spatial directions and three rotational directions for connection to a computational unit with a display which displays at least partial areas of the object, the apparatus comprising:
a. a carrier element;
b. an input element movable relative to the carrier element for input of the control signals;
c. an actuator arranged at the carrier element or at the input element;
d. wherein the actuator is designed so as to influence the size of the object on the display and/or a sensitivity of the input of at least one control signal.

2. (canceled)

3. (canceled)

4. Apparatus according to claim 1, wherein the actuator is designed as a rotatable element which is rotatably arranged around the input element.

5. Apparatus according to claim 1, wherein the actuator encompasses the input element in a circle.

6. Apparatus according to claim 4, wherein the grip surface of the actuator is curved orthogonal to the rotational direction of the actuator.

7. Apparatus according to claim 1, wherein the actuator is designed so as to select a choice in a display of the carrier element.

8. Apparatus according to claim 1, wherein the actuator is designed so as to detect sensitivity of the input of control signals.

9. Apparatus according to claim 1, wherein the carrier element comprises keys for additional inputs of a user, and wherein the lighting of the keys depends on a selectable function of the apparatus.

10. Apparatus according to claim 1, wherein the input element is arranged on printed circuit board of the carrier element.

11. Apparatus according to claim 1, wherein a movement of the actuator is detected by a photo sensor or a light barrier.

12. Apparatus according to claim 1, wherein a cover plate of the carrier element comprises a preferably circular recess through which a part of input element extends.

13. Apparatus according to claim 12, wherein the actuator is arranged at the boundary of the recess.

14. Apparatus according to claim 1, wherein the input element comprises exchangeable grip areas.

15. Apparatus according to claim 1, wherein the apparatus is designed so that the control signals are for moving an object in less than three spatial directions and/or less than three rotational directions.

16. Apparatus for input of control signals for moving an object in three spatial directions and three rotational directions for connection to a computational unit with a display which displays at least partial areas of the object, the apparatus comprising:
a. a carrier element;
b. an input element movable relative to the carrier element for input of the control signals;
c. an actuator arranged at the carrier element;
d. wherein the actuator is designed as a rotatable or slideable element in order to detect further inputs of a user; and
e. wherein the actuator extends at least partially around the input element.

17. Apparatus according to claim 16, wherein the actuator is designed as a rotatable element which is rotatably arranged around the input element.

18. Apparatus according to claim 17, wherein the grip surface of the actuator is curved orthogonal to the rotational direction of the actuator.

19. Apparatus according to claim 16, wherein the actuator encompasses the input element in a circle.

20. Apparatus according to claim 16, wherein the actuator is designed so as to select a choice in a display of the carrier element.

21. Apparatus for input of control signals for moving an object in three spatial directions and three rotational directions for connection to a computational unit with a display which displays at least partial areas of the object, the apparatus comprising:
a. a carrier element;
b. an input element movable relative to the carrier element for input of the control signals;
c. an actuator arranged at the input element;
d. wherein the actuator is designed as a rotatable or slideable element for detecting additional inputs of a user.

22. Apparatus according to claim 21, wherein the actuator is designed as a rotatable element which is rotatably arranged around the input element.

23. Apparatus according to claim 22, wherein the grip surface of the actuator is curved orthogonal to the rotational direction of the actuator.

24. Apparatus according to claim 21, wherein the actuator encompasses the input element in a circle.

25. Apparatus according to claim 21, wherein the actuator is designed so as to select a choice in a display of the carrier element.
